(19) United States
(12) Patent Application Publication
(10) Pub. No.: US 2015/0154778 A1
(43) Pub. Date: Jun. 4, 2015

(54) SYSTEMS AND METHODS FOR DYNAMIC IMAGE RENDERING

(71) Applicant: Calgary Scientific, Inc., Calgary (CA)

(72) Inventor: Matthew Charles Hughes, Calgary (CA)

(21) Appl. No.: 14/548,357

(22) Filed: Nov. 20, 2014

Related U.S. Application Data
(60) Provisional application No. 61/910,272, filed on Nov. 29, 2013.

(51) Int. Cl. G06T 11/60; G06F 19/00

(52) U.S. Cl. CPC G06T 11/60; G06F 19/321; G06F 19/322

(57) ABSTRACT

A method for dynamic image rendering comprises receiving information indicative of a display resolution associated with a client device. The method also comprises determining that the display resolution of the client device is greater than a native resolution of a source image, and transmitting the source image at its native resolution. The method further comprises rendering an overlay at the display resolution associated with the client device, and transmitting the overlay to the client device.

### CROSS-REFERENCE TO RELATED APPLICATION

This application claims priority to U.S. Provisional Patent Application No. 61/910,272, filed Nov. 29, 2013, entitled “SYSTEMS AND METHODS FOR DYNAMIC IMAGE RENDERING,” the disclosure of which is incorporated herein by reference in its entirety.

### TECHNICAL FIELD

The present disclosure relates generally to systems for remote access and viewing images, such as diagnostic images, more particularly, to systems and methods for dynamically allocating image rendering tasks between client devices and a server in order to optimize resource consumption across a diagnostic or other network platform.

### BACKGROUND

Health care professionals rely heavily on sophistical diagnostic imaging system to aid in rendering quick, reliable, cost-efficient, and, most importantly, medically-effective services to patients. Before relatively recent efforts to digitize medical imaging data for electronic access, a doctor or medical professional would request a diagnostic test (such as an X-ray, magnetic resonance imaging (MRI), computer tomography (CT), ultrasound, positron emission tomography (PET), etc.) for a patient. The surgeon would have to wait for the test results to be compiled and printed in a format that is readable by the doctor (which, before computers, typically required some sort of hardcopy development) before reviewing the images in order to provide a diagnosis and a treatment plan. Not only was such a process incredibly time consuming and inefficient, it created a tremendous amount of costly administrative overhead to print, store, manage, and track the library of imaging data for the multitude of patients that undergo such diagnostic procedures.

As computer systems become more sophisticated over the last few decades, medical imaging software enabled digitization and storage of the medical imaging data in digital form. As digital image processing hardware and software became more robust, the speed and efficiency with which the medical images could be processed for viewing dramatically increased. Doctors and radiologists were able to view diagnostic imaging results on computer monitors within minutes of completion of the tests. The results could also be stored digitally in hard drives, where they would be later retrieved, reducing the overhead associated with maintaining large libraries of medical imaging hardcopy data.

Although these capabilities lowered costs associated with diagnostic testing, they were still cumbersome and inefficient. For example, doctors and radiologists were generally tethered to the computer systems that were physically located in the diagnostic testing facility. If the diagnostic imaging facility was not located on the same campus as the healthcare facility, the records still had to be processed for printing and delivery to the doctor.

Recently, computer networks and workstations have become faster, more portable, more secure, and possess increased capabilities for complex image processing and rendering tasks. As such, the potential for fast and secure viewing/sharing of medical imaging data on portable client devices (such as laptops, tablets, smartphones, wearable media device, etc.) has grown dramatically. Although distribution of image and video content in general has become more common in recent years, diagnostic medical imaging distribution is unique. For example, because of privacy considerations and regulations (such as HIPAA), medical image data cannot be simply made available for download or distribution, as with conventional images. To maintain privacy, portable devices are limited in the amount and type of data that can be stored and downloaded to the device.

One solution for addressing this problem is to allow a client device to remotely view (without downloading) image information rendered and prepared for display by the server and subsequently sent to a thin-client image viewing application running on the client device. Because the complete image is prepared for display on the client device by an image rendering service on the server, the risk of unauthorized downloading of confidential information by the client device is limited. Importantly, however, transmission of the full-size image by the server to the thin-client service consumes a large amount of bandwidth. Furthermore, as the user of the thin-client performs functions like pan and zoom, the server must prepare a new full-size image for delivery to the thin-client service running on the client device. Consequently, thin-client image viewing schemes can be unnecessarily inefficient, particularly when multiple frames of diagnostic images are required.

The presently disclosed systems and methods for dynamic rendering of imaging data are directed to overcoming one or more of the problems set forth above and/or other problems in the art.

### SUMMARY

According to one aspect, the present disclosure is directed to a method for dynamic image rendering. The method may comprise receiving, at a processor associated with an image server, information indicative of a display resolution associated with a client device. The method may also comprise determining, by the processor, that the display resolution of the client device is greater than a native resolution of a source image. The method may further comprise transmitting, by the processor to the client device, the source image at its native resolution. The method may also comprise rendering, by the processor at the image server, an overlay at the display resolution associated with the client device. The method may further comprise transmitting, by the processor to the client device, the overlay.

In accordance with another aspect, the present disclosure is directed to a method for dynamic rendering of diagnostic image information. The method may comprise receiving, at a processor associated with an imaging server, a request for diagnostic image data, the request having been generated at a client device. The method may also comprise determining, by the processor, a graphics rendering capability associated with the client device. The method may further comprise customizing a graphics rendering process to be performed by the processor, based, at least in part, on the graphics rendering capability associated with the client device. The method may also comprise generating, by the processor using the selected graphics rendering process, an image associated with the received request for diagnostic image data. The method may further comprise transmitting, by the processor to the client device, the generated image for display on the client device.

In accordance with another aspect, the present disclosure is directed to a dynamic image rendering system, comprising an image rendering service running on a client device and configured to render images for display at the client device. The dynamic image rendering system may also comprise a server device communicatively coupled to the image rendering service running on the client device, the server device comprising a processor. The processor may be configured to receive information indicative of a display resolution associated with the client device, and determine that the display resolution of the client device is greater than a native resolution of a source image. The processor may also be configured to transmit the source image at its native resolution to the client device. The processor may be further configured to generate an overlay at the display resolution associated with the client device, and transmit the overlay to the client device.

### BRIEF DESCRIPTION OF THE DRAWINGS

FIG. 1 provides a diagrammatic view of an exemplary diagnostic image sharing network in which processes and system consistent with the disclosed embodiments may be deployed;

FIG. 2 provides a diagrammatic view of an exemplary communication flow between a server and one or more client systems, in accordance with certain disclosed embodiments;

FIG. 3 provides a schematic diagram of an exemplary network for providing remote access to diagnostic imaging information, consistent with certain disclosed embodiments;

FIG. 4 provides a schematic view of exemplary components that may be associated with one or more of the client and server image rendering systems, in accordance with certain disclosed embodiments;

FIG. 5 provides a flowchart illustrating an exemplary server-side process for dynamic image rendering in a hybrid client-server image rendering architecture, consistent with certain disclosed embodiments;

FIG. 6 provides a flowchart illustrating an exemplary client-side process for dynamic image rendering in a hybrid client-server image rendering architecture, in accordance with certain disclosed embodiments; and

FIG. 7 provides a flowchart illustrating yet another exemplary method for dynamic image rendering in a hybrid client-server image rendering architecture, consistent with the disclosed embodiments.

### DETAILED DESCRIPTION

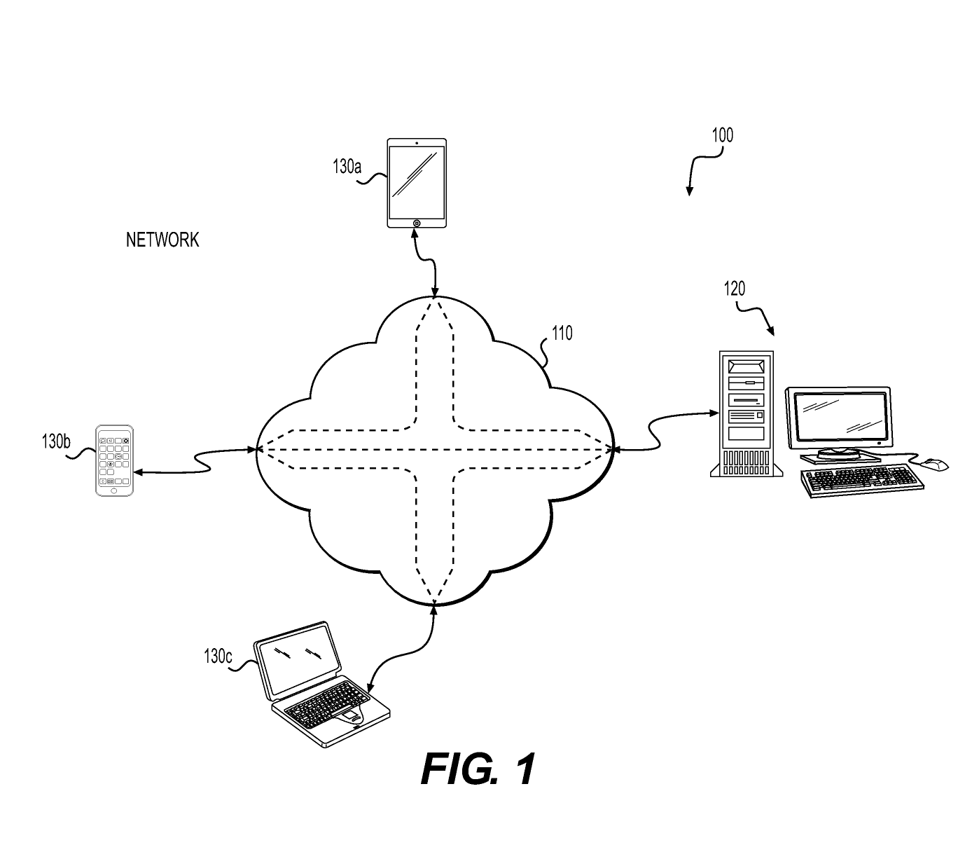

FIG. 1 provides a diagram of an exemplary diagnostic image sharing network 100 over which processes and systems consistent with the presently disclosed dynamic image rendering service may be implemented. As illustrated in FIG. 1, diagnostic image sharing network 100 may include a plurality of devices that may be communicatively coupled to one another (or to a centralized server) to facilitate the distribution of data, such as diagnostic imaging data, between or among the constituent devices. According to one embodiment, diagnostic image sharing network 100 may include an image server 120 and one or more client devices 130a-130c, each of which may be communicatively coupled to communication network 110. The listing of components illustrated in FIG. 1 is exemplary only and not intended to be limiting. Indeed, it is contemplated that additional, fewer, and/or different devices than those shown in FIG. 1 may be included as part of diagnostic image sharing network 100 without departing from the scope of the present disclosure.

Communication network 110 may include or embody any data or telecommunications network that allows any number of network compatible devices, such as image server 120 and client devices 130a-130c, to exchange data with other network compatible devices, both internal and external to diagnostic image sharing network 100. For example, communication network 110 may provide a gateway for coupling image server 120 and/or client devices 130a-130c with one or more servers on the World Wide Web using any combination wired or wireless communication platforms. Communication network 110 may include a wireless networking platform such as, for example, a satellite communication system, a cellular communication system, or any other platform for communicating data with one or more geographically dispersed assets (e.g., Bluetooth, microwave, point-to-point wireless, point-to-multipoint wireless, multipoint-to-multipoint wireless.) Alternatively or additionally, communication network 102 may include or embody wireline networks such as, for example, Ethernet, fiber optic, waveguide, or any other type of wired communication network.

Image server 120 may include any processor-based computer system suitable for configuration as a centralized node for distributing and/or sharing diagnostic imaging data with one or more other computer systems. According to one embodiment, image server 120 may include a plurality of computer systems coupled to an image database containing a diagnostic image library associated with a healthcare facility, such as a hospital. In general, image server 120 may be configured to support a large number of simultaneous connections with client devices 130a-130b for providing access to images stored in a diagnostic imaging database. As such, image server 120 may be configured to process incoming requests for diagnostic image data from client devices 130a-130b, perform server-side image processing and rendering functions, and deliver and/or serve the processed image information to the requesting client device. According to one embodiment, image server 120 may include a Windows or Linux-based multi-processor computing platform that is coupled to a diagnostic imaging database.

Client devices 130a-130c may each include any processor-based computing device suitable for receiving image data from image server 120 and render the image data on a display. Client devices 130a-130c may be configured for establishing a secure connection with image server 120 and/or other client devices coupled to communication network 110 in order to send and receive image information across communication network 110. Client devices 130a-130c may be include smart phones, tablets, laptop/desktop/netbook computing devices, wearable media consumption devices (e.g., optical head-mounted display (OHMD), smart watch, etc.), or any other types of processor-based computing system suitable for accessing image server 120 and rendering diagnostic images and related data on a display associated with the respective device. According to one embodiment, client devices 130a-130c may configured with specialized sharing software, such as ResolutionMD client software available from Calgary Scientific, Inc., of Calgary, Alberta, Canada.

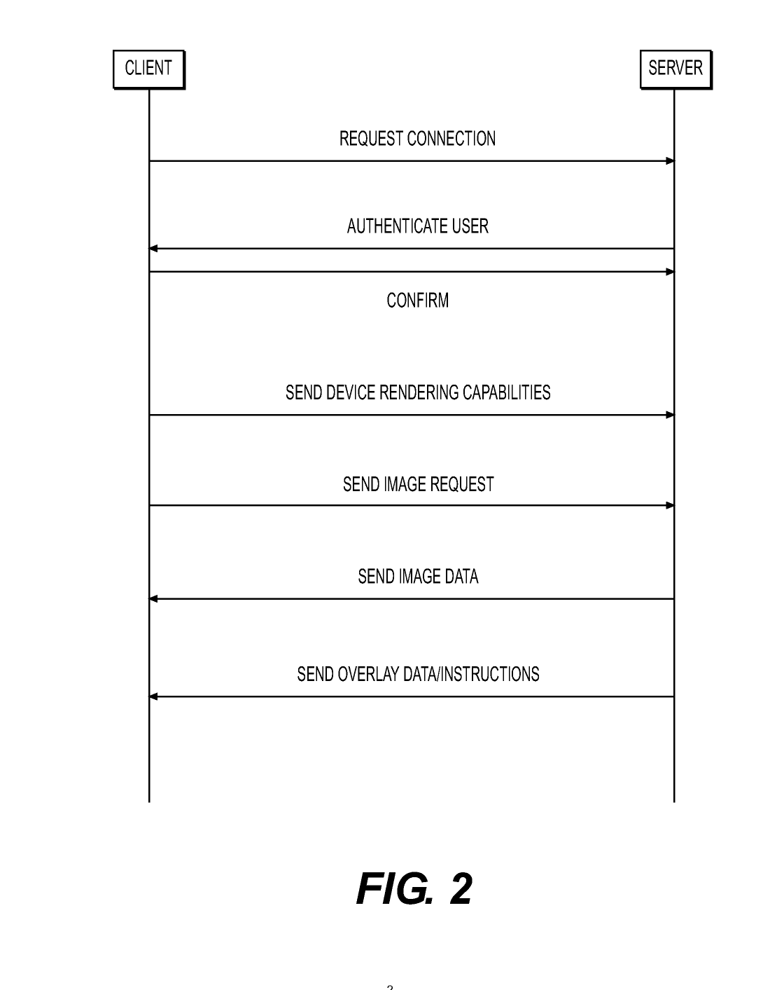

As explained, each of server 120 and/or client devices 130a-130c may be configured to establish a secure, encrypted, private communication channel with one or more other devices connected to network 110. According to one embodiment, each of server 120 and client devices 130a-130c may be configured to establish a virtual private shared network through a dedicated remote access server for sharing diagnostic information over communication network 110. For example, such remote access program software may be part of the PureWeb architecture available from Calgary Scientific, Inc., Calgary, Alberta, Canada, and which includes image sharing and collaboration functionality. In accordance with an exemplary embodiment, image server 120 may embody the remote access server as well as the ResolutionMD server software. FIG. 2 illustrates an exemplary communication flow by which client devices 130a-130b may establish a private, secure connection with image server 120.

As illustrated in FIG. 2, one or more of client devices 130a-130c may request a secure connection with image server 120 (or whichever server is designated as the remote access server for the PureWeb and/or ResolutionMD platforms). According to one embodiment, this request may be manually initiated by a user of client device 130a-130c. Alternatively or additionally, this request may be automatically generated when a user starts a ResolutionMD or PureWeb application on the client device.

Server 120 may be configured may respond to the request by invoking an authentication/confirmation handshake process. This authentication process is designed to ensure that only registered and approved client devices 130a-130c are given remote access to diagnostic imaging data.

Once a secure connection has been established between a client device and image server 120, image server 120 can share diagnostic image information with the client device. Processes and methods consistent with the disclosed embodiments provide a solution for enabling image server 120 to deliver diagnostic image information to client devices while conserving image processing resources and minimizing the amount of data transmitted between image server 120 and the client device. According to one embodiment, image server 120 accomplishes this by proactively determining the image processing and rendering capabilities of the client device that is requesting the diagnostic information. This information may be provided by the client device after authentication of the client device has been confirmed.

Once the device rendering capabilities of the client device have been determined, the client device may send a request to access a diagnostic image stored on image server 120. Based on the image processing/rendering capabilities of the client device, image server 120 may be configured to determine how to distribute the various image formatting and rendering tasks between the client device and image server 120. Because image server 120 is configured to handle numerous requests, it may be advantageous for image server 120 to offload any image processing and rendering tasks that may be efficiently performed by the client device. Also, by allowing the client device perform image rendering tasks, image server 120 can typically transmit less information to the client device, conserving costly bandwidth resources and reducing download wait times.

As image processing and rendering capabilities of portable devices are quickly becoming more sophisticated, image server 120 can break the image information into separate components, and transmit the portions of the image information that can be easily processed by the client device. The portions of the image data that are more difficult to render, image server 120 may process on the server-side and transmit the processed data to the client device, for display. For example, most client-side rendering engines include image scaling capabilities for reformatting and scaling images of different sizes to conform the display size of the client device. In contrast, certain information, such as text, orientation labels, and caliper grid information that overlays the image itself are generally not easily scaled without degrading the quality of the overlay. As such, image server 120 may separately send the image data and the overlay data to the client device.

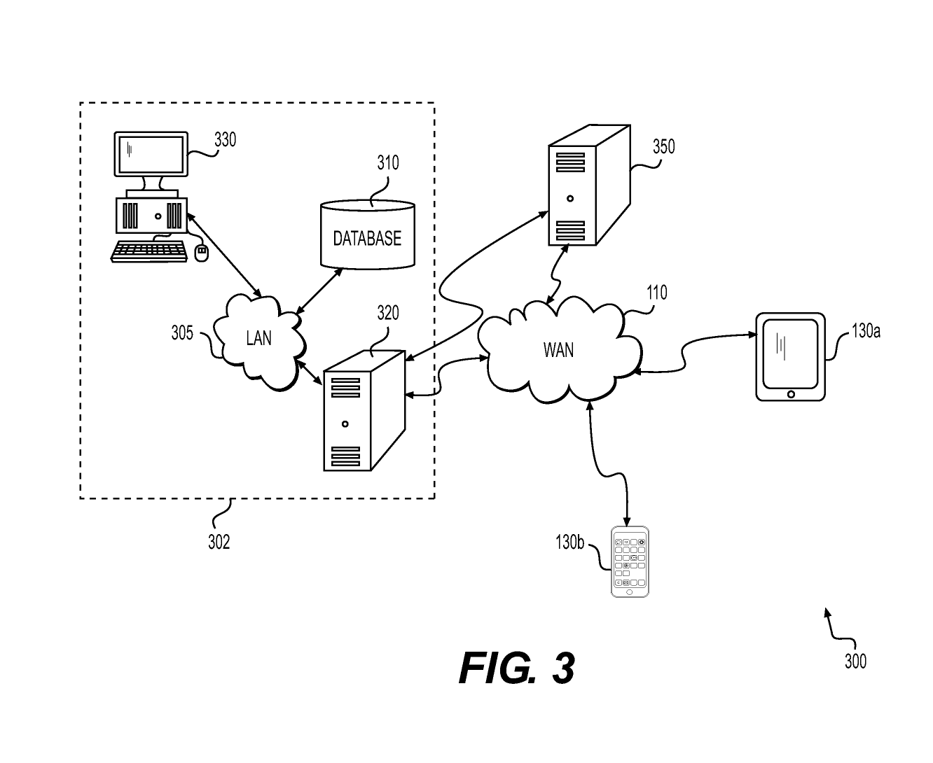

With the above overview as an introduction, reference is now made to FIG. 3 where there is illustrated an environment 300 for patient image data viewing, collaboration and transfer via a computer network. An imaging server computer 320 may be provided at a facility 302 (e.g., a hospital or other care facility) within an existing network as part of a medical imaging application to provide a mechanism to access data files, such as patient image files (studies) resident within a, e.g., a Picture Archiving and Communication Systems (PACS) database 310. Using PACS technology, a data file stored in the PACS database 320 may be retrieved and transferred to, for example, a diagnostic workstation 330 using a Digital Imaging and Communications in Medicine (DICOM) communications protocol where it is processed for viewing by a medical practitioner. The diagnostic workstation 330 may be connected to the PACS database 310, for example, via a Local Area Network (LAN) 305 such as an internal hospital network or remotely via, for example, a Wide Area Network (WAN) 110 or the Internet. Metadata may be accessed from the PACS database 310 using a DICOM query protocol, and using a DICOM communications protocol on the LAN 305, information may be shared. The server computer 320 may comprise a ResolutionMD server available from Calgary Scientific, Inc., of Calgary, Alberta, Canada. The server computer 320 may be one or more servers that provide other functionalities within the facility 302.

A remote access server 350 is connected, for example, via the computer network 110 or the Local Area Network (LAN) 305 to the facility 302 and one or more client computing devices 130a, 130b. The remote access server 350 includes server remote access program software that is used to connect various client computing devices to applications, such as the medical imaging application provided by the server computer 320. The server remote access program software provides connection marshalling and application process management across the environment 300. The server remote access program software may field connections from remote client computing devices and broker the ongoing communication session between the client computing devices and the medical imaging application. For example, the remote access program software may be part of the PureWeb architecture available from Calgary Scientific, Inc., Calgary, Alberta, Canada, and which includes collaboration functionality.

The client computing devices 130a, 130b may include a tablet device or mobile handset, such as, for example, an iPad, an iPhone, an Android, or a Windows-based device connected via a computer network 110 such as, for example, the Internet, to a remote access server 350. It is noted that the connections to the communication network 110 may be any type of connection, for example, Wi-Fi (IEEE 802.11x), WiMax (IEEE 802.16), Ethernet, 3G, 4G, LTE etc.

A client remote access program software may be designed for providing user interaction for displaying data and/or imagery in a human comprehensible fashion and for determining user input data in dependence upon received user instructions for interacting with the application program using, for example, a graphical display with touch-sensitive display of the client computing devices 130a, 130b. An example client computing device 130a, 130b is detailed with reference to FIG. 1.

The operation of server remote access program software with the client remote access program software can be performed in cooperation with a state model (not shown). When executed, the client remote access program software updates the state model in accordance with user input data received from a user interface program or imagery currently being displayed by the client computing device software. The user input data may be determined as a result of a gesture, such as a swipe of the touch-sensitive display and maintained within the state model. The remote access program software may provide the updated application state within the state model to the server remote access program software running on the remote access server 350. The server remote access program software may interpret the updated application state and make a request to the server 320 for additional screen or application data. The server remote access program software also updates the state model in accordance with the screen or application data, generates presentation data in accordance with the updated state model, and provides the same to the client remote access program software on the client computing device 130a, 130b for display. In the environment of the present disclosure, the state model may contain other information, such as a current slice being viewed by a user.

To provide scrolling at the client computing device 130a, 130b, the determined swipe velocity may be populated into the state model as part of the application state and communicated by the client remote access program software to the server remote access program software. Based on the information contained in the state model, the server remote access program software may make a request to the server 320 at the facility 302 hosting the patient image data to provide the requested slices. As such, the slices may be provided by the server 320 at a rate determined in accordance with the measured velocity of the swipe. For example, for relatively slower swipes, a slow scroll velocity is determined, whereas for relatively faster swipes, a faster scroll velocity is determined up to a maximum velocity. The slices would be communicated by the server remote access program software to the client remote access program software for display at the client computing device 130a, 130b.

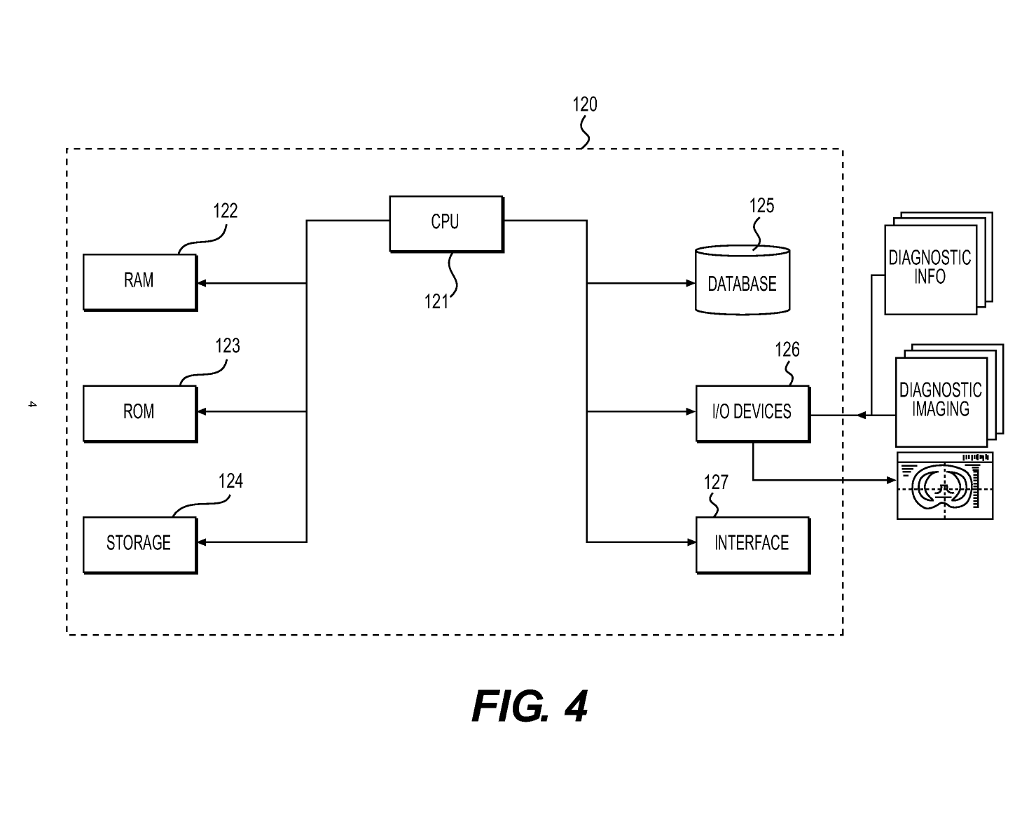

FIG. 4 provides a schematic diagram illustrating exemplary components of a computer system that is suitable for processing image information. Specifically, FIG. 4 is a schematic block diagram depicting exemplary subcomponents of client devices 130a-130b, server 120, or any other suitable computer system that includes an image rendering capability in accordance with certain disclosed embodiments. Although FIG. 4 is described as being associated with image server 120, it is contemplated that the schematic illustrated in FIG. 4 is applicable to any processor-based image rendering device that may be connected to diagnostic image sharing network 100.

As explained, image server 120 may be any processor-based computing system that is configured to receive requests for image information from one or more client devices 130a-130c, determine an efficient distribution of image rendering tasks based on the image rendering capabilities of the client devices 130a-130c, and provide the image information and any overlay information to the client device in accordance with the image rendering strategy. Non-limiting examples of image server 120 include a desktop or notebook computer, a tablet device, a smartphone, wearable or handheld computers, or any other suitable processor-based computing system.

For example, as illustrated in FIG. 4, image server 120 may include one or more hardware and/or software components configured to execute software programs, such as image processing and rendering software, diagnostic image sharing software (e.g., ResolutionMD), and remote communication software (e.g., PureWeb). According to one embodiment, image server 120 may include one or more hardware components such as, for example, a central processing unit (CPU) or microprocessor 121, a random access memory (RAM) module 122, a read-only memory (ROM) module 123, a memory or data storage module 124, a database 125, one or more input/output (I/O) devices 126, and an interface 127. Alternatively and/or additionally, image server 120 may include one or more software media components such as, for example, a computer-readable medium including computer-executable instructions for performing methods consistent with certain disclosed embodiments. It is contemplated that one or more of the hardware components listed above may be implemented using software. For example, storage 124 may include a software partition associated with one or more other hardware components of image server 120. Image server 120 may include additional, fewer, and/or different components than those listed above. It is understood that the components listed above are exemplary only and not intended to be limiting.

CPU 121 may include one or more processors, each configured to execute instructions and process data to perform one or more functions associated with image server 120. As illustrated in FIG. 4, CPU 121 may be communicatively coupled to RAM 122, ROM 123, storage 124, database 125, I/O devices 126, and interface 127. CPU 121 may be configured to execute sequences of computer program instructions to perform various processes, which will be described in detail below. The computer program instructions may be loaded into RAM 122 for execution by CPU 121.

RAM 122 and ROM 123 may each include one or more devices for storing information associated with an operation of image server 120 and/or CPU 121. For example, ROM 123 may include a memory device configured to access and store information associated with image server 120, including information for identifying, initializing, and monitoring the operation of one or more components and subsystems of image server 120. RAM 122 may include a memory device for storing data associated with one or more operations of CPU 121. For example, ROM 123 may load instructions into RAM 122 for execution by CPU 121.

Storage 124 may include any type of mass storage device configured to store information that CPU 121 may need to perform processes consistent with the disclosed embodiments. For example, storage 354 may include one or more magnetic and/or optical disk devices, such as hard drives, CD-ROMs, DVD-ROMs, or any other type of mass media device. Alternatively or additionally, storage 124 may include flash memory mass media storage or other semiconductor-based storage medium.

Database 125 may include one or more software and/or hardware components that cooperate to store, organize, sort, filter, and/or arrange data used by image server 120 and/or CPU 121. For example, database 125 may include a library of digital diagnostic images associated with one or more patients. CPU 121 may access the information stored in database 125 to retrieve diagnostic images requested by one or more of the client devices 130a-130c. CPU 121 may also be configured to receive any markups and modifications made to the image by users of client devices 130a-130c. This information may be recorded and stored in database 125 for future use. It is contemplated that database 125 may store additional and/or different information than that listed above.

I/O devices 126 may include one or more components configured to communicate information with a user associated with image server 120. For example, I/O devices may include a console with an integrated keyboard and mouse to allow a user to input parameters associated with image server 120. I/O devices 126 may also include a display including a graphical user interface (GUI) for outputting information on a display monitor. I/O devices 126 may also include peripheral devices such as, for example, a printer for printing information associated with image server 120, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 127 may include one or more components configured to transmit and receive data via a communication network, such as the Internet, a local area network, a workstation peer-to-peer network, a direct link network, a wireless network, or any other suitable communication platform. For example, interface 127 may include one or more modulators, demodulators, multiplexers, demultiplexers, network communication devices, wireless devices, antennas, modems, and any other type of device configured to enable data communication via a communication network. According to one embodiment, interface 127 may be coupled to or include wireless communication devices, such as a module or modules configured to transmit information wirelessly using Wi-Fi or Bluetooth wireless protocols.

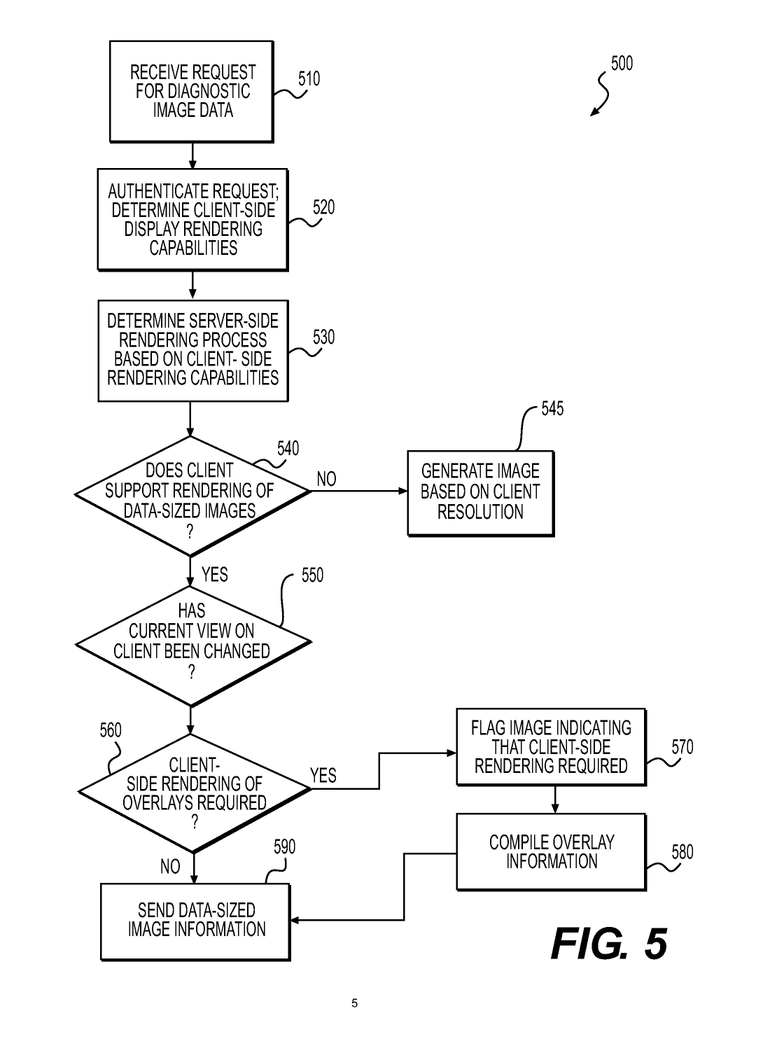

Processes and methods consistent with the disclosed embodiments provide a platform for efficiently sharing diagnostic image information between a centralized image server 120 and one or more client devices 130a-130c. In particular, the presently disclosed features and associated systems provide a solution by which a centralized image server 120 receives requests for image data from one or more client devices 130a-130b, determines the image processing/rendering capabilities of the client devices, devises an image rendering and delivery strategy based on the capabilities of the client device(s) 130a-130c, and formats and delivers the image information to the client device based on the determined image rendering strategy. FIGS. 5-7 illustrate exemplary embodiments for dynamic image rendering.

FIG. 5 illustrates a flowchart 500 that described an exemplary process performed by image server 120 in accordance with the presently disclosed embodiments. As illustrated in FIG. 5, the server-side process for dynamic image rendering commences upon receipt of a request for diagnostic image information from a client device (Step 510). For example, a client device 130a may include an iPad associated with a doctor or surgeon. The doctor may request a patient's CT scan information using an image sharing application on client device 130a, such as the ResMD app. Once the username and password of the doctor using the client device 130a has been authenticated, the doctor may generate a request to log in and view the CT scan information associated with one of his patients. It is contemplated that image server 120 (and/or the dynamic image rendering processes performed thereby) may require alternative or additional forms of user and/or device authentication. For example, in some cases, device authentication may be used to ensure that only devices that are issued by the particular organization that is sharing the diagnostic imaging data. It should be noted that user authentication is optional, and/or may be used only where added security is desired.

Upon receiving the requested diagnostic information, image server 120 may determine the display rendering capabilities associated with the client device 130a (Step 520). Display rendering capabilities, as the term is used herein, may include one or more of a number of different characteristics associated with an image rendering engine one the client device. Display rendering capabilities may include, for example, parameters associated with the display, such as the display resolution. Alternatively or additionally, display rendering capabilities may include specific features of the image rendering services available on the client device. For example, display rendering capabilities may include information indicative of whether the image rendering service is able to scale images and, if so, what type of image scaling processes are used. Other examples of display rendering capabilities include metadata, orientation labels, caliper labels, slice rendering, lens, reference lines, annotations, measurements, and GSPS. Image server 120 is capable of identifying whether a client device is able to perform one or more of these display rendering capabilities. Image server 120 may be configured to customize the server-side image rendering capabilities (and provide instructions to the client device for implementing client-side image rendering processes) based on the determination of the image rendering capabilities of the client device.

Once the display capabilities associated with the client device has been determined, image server 120 may be configured to determine the server-side image rendering process (Step 530). By way of example, if image server 120 determines that the image rendering service associated with the client device is incapable of digitally scaling certain types of data, image server 120 may decide that certain image scaling tasks are going to remain as server-side rendering tasks. Similarly, if image server 120 determined that the image rendering service associated with the client device is capable of digitally scaling image data, image server 120 may be configured determine that the image scaling tasks can be offloaded to the client device.

Once the server-side image rendering tasks have been determined, image server 120 may determine whether the client supports rendering of data-sized images (Step 540). If the client does not support data-sized images, image server may compile the image information requested by the client device, and generate the image at the display resolution of the client device. Continuing with the example above, if image server 120 determines (based on the client capabilities) that the image must be scaled prior to forwarding to the client device (because the client does not support rendering of data-sized images), image server 120 may be configured to scale the image from the image's native size to the size of the display. If, on the other hand, image server 120 determines that the client device will perform the image scaling functions, image server may simply retrieve the image in its native resolution, and prepare the native image for delivery to the client device. If, on the other hand image server 120 determines that the client supports rendering of data-sized images (Step 540: Yes), image server 120 may then determine whether a current view on the client device has changed (i.e., whether a view associated with a currently-visible slice has changed or whether the window/level has changed (Step 550).

Prior to transmitting the image information to the client device, image server 120 may be configured to determine whether any client-side rendering is required (Step 550). For example, image server 120 may determine if the overlay information contains data that cannot be rendered on by the image rendering service of the client device (such as GSPS or annotations). Furthermore, in situations in which the client device is incapable of scaling the image (e.g., if the client device does not support rendering of data-sized images), image server 120 may be configured to render any overlay data along with the image information. Overlay data, as the term is used herein, generally refers to data that is not part of the native image, but that is nonetheless included with the image to aid in the identification of the image, the patient, etc. Non-limiting examples of overlay data include, for example, image metadata, time and date information, orientation labels, caliper or measurement grid overlays, anatomical landmark data, labels and other notes, or any other non-image data that may nevertheless be useful in a diagnostic capacity. If the image information and overlay information is scaled and rendered simultaneously by image server 120, image server 120 may determine that no client-side rendering is required (Step 550: No), and may send the image information to the client device, for display (Step 560).

If, on the other hand, image server 120 determines that at least some client side rendering is required (Step 550: Yes), image server 120 may flag the image information to indicate that some additional client-side rendering is required (Step 570). This indication may ensure that, when the image information is transmitted to the client device, the image rendering service associated with the client device includes the additional information before rendering the image for display on the client device. According to one embodiment, additional client-side rendering may be required only if the overlay and the image information is rendered separately. One example is when the image information is sent in its native format (for scaling by the image rendering service), but the overlay information is rendered on the server-side. Image server 120 may compile the image overlay information including, for example, the orientation label information, metadata, patient information, caliper measurement grids, and any other data to be included on the overlay of the image (Step 580). Image server 120 may send the image information (along with the overlay notification flag) (Step 590) along with the overlay information.

It should be noted that the presently disclosed embodiments are applicable in collaborative sessions. During a collaborative session, multiple client devices register to receive diagnostic image data from image server 120. In some cases, the client devices that subscribed to the collaborative session have different image processing and rendering capabilities. For example, one client may be a very capable client device, which, using the dynamic image rendering techniques described herein, would result in a significant amount of the image rendering tasks being performed on the client-side. If, however, one or more of the other client devices of the collaborative session have fewer client-side image rendering capabilities than the more capable client(s), image server 120 may customize the client-server image rendering strategy for all of the clients in the session based on the less capable device(s). As such, image server 120 may ensure that all of the clients in the session are able to receive and render the same set of images/overlays generated by a single server-side render process. It should be noted, however, that this process of performing server-side rendering for collaboration sessions based on the capabilities of the least-capable client device that is registered to the session is exemplary only, and designed primarily for efficiency. Those skilled in the art will appreciate that it is possible for image server 120 to develop separate client-server image rendering processes that is unique to each device in the session, without departing from the scope of the present disclosure.

In collaborative sessions, additional measures may be used to ensure that less capable client devices are synchronized to the session. For example, a client device may be configured to skip certain rendering steps/frames (e.g., rendering only every other or every third transaction of the collaboration session) in order to be able to keep pace the more capable devices in the session.

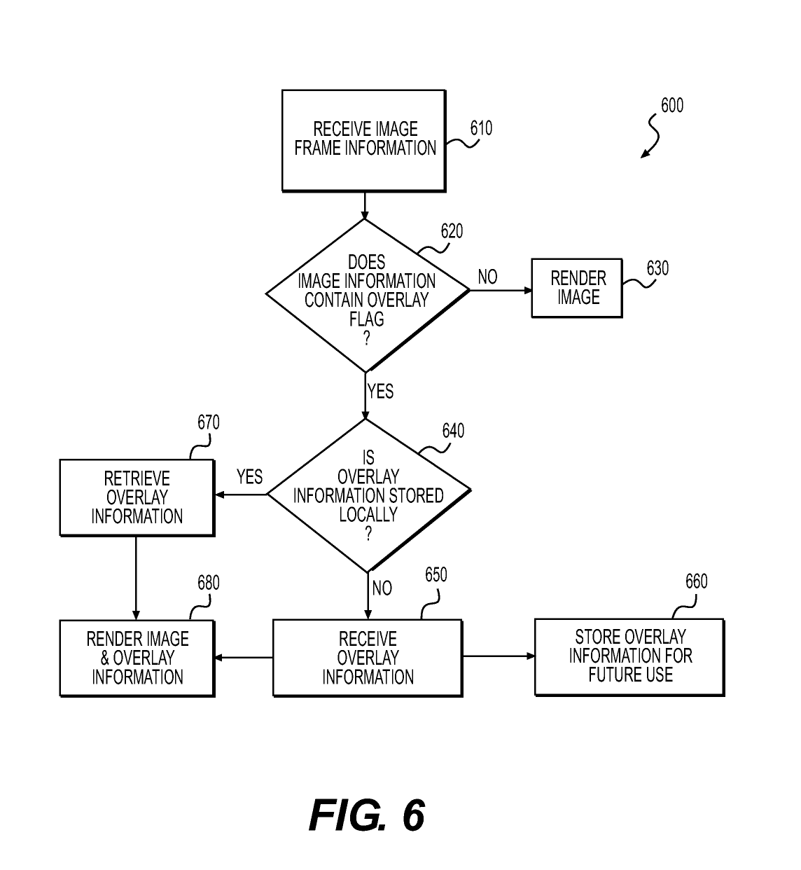

FIG. 6 illustrates an exemplary client-side process 600 for dynamic rendering of diagnostic images, consistent with the disclosed embodiments. The client-side process commences when image frame information associated with the requested image is received at the client device by image server (Step 610). Once the image information is received, the image rendering service of the client device scans the image in order to detect an overlay flag (Step 620). If the image rendering service on the client device determines that there is not an overlay flag contained in the image information (indicating that the image information is ready for immediate rendering and display by the client device), the image rendering service associated with the client device may render the image (Step 630).

If on the other hand, the image rendering service determines that there is an overlay flag contained in the image information (indicating the image must be rendered with an overlay) (Step 620: Yes), the client device may determine whether overlay information associated with the image has been previously stored (Step 640). It is contemplated that overlay information for related images (such as adjacent frames of CT scan data) may be reused for multiple images. In these situations, it may only be necessary to send the overlay information once for a series of images, further limiting the amount of data that is required to be transmitted across the network.

If there is not usable overlay information stored (Step 640: No), the image rendering service of the client device may await receipt of overlay information from image server 120 (Step 650). Once the overlay information is received from the image server 120, the image rendering service of the client device may store the overlay information for future use in subsequent images.

If, on the other hand, image rendering service of the client device determines that there is reusable overlay information stored locally (Step 640: Yes), the image rendering service may retrieve the overlay information (Step 670). Once retrieved, the image rendering service may be configured to render the image and overlay information for display on the client device (Step 680).

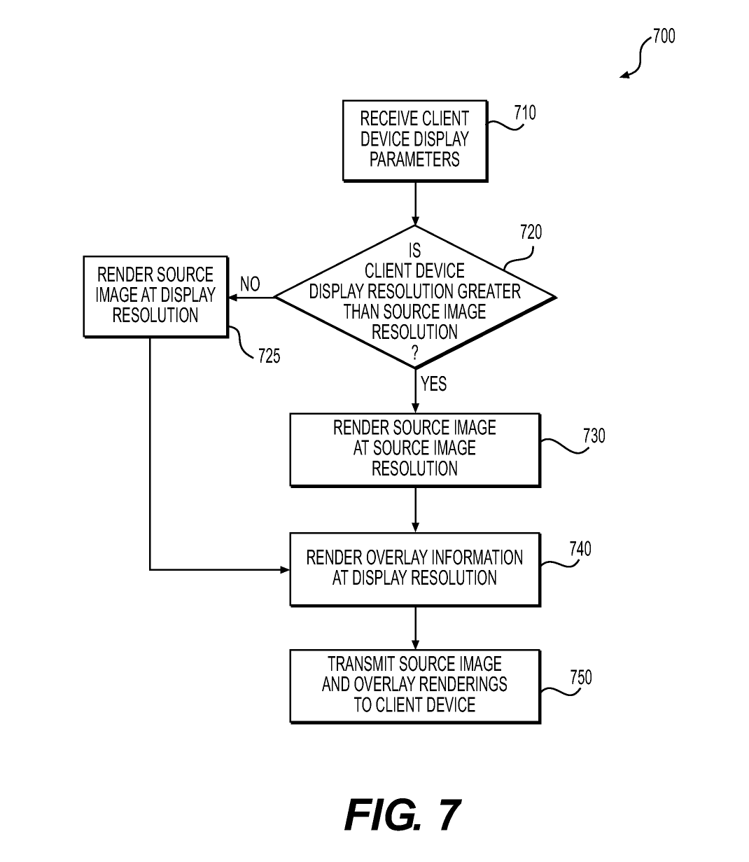

FIG. 7 illustrates another exemplary server-side process 700 for dynamic rendering of images in accordance with certain exemplary disclosed embodiments. The process commences upon receipt of a request for diagnostic image data and device display parameters associated with the client device (Step 710). For example, image server 120 may be configured to determine, based on the device display parameters, a resolution of a display of the client device.

Image server may be configured to determine whether the display resolution associated with the client device is greater than a native resolution of the source image (Step 720). If the resolution of the display device is less than the native resolution of the image (Step 730: No), the server-side rendering service may be configured to re-render the image at a resolution associated with the display device (Step 725).

If the resolution of the display device is greater than the native resolution of the image (Step 720: Yes), a rendering service associated with image server 120 may be configured prepare the source image (at its native resolution) for transmission to a client device (Step 730). The image rendering service associated with the server device may render the overlay information to reformat the image to resolution of the display device (Step 740), to ensure that the overlay information is ready for immediate rendering on the client display, without requiring scaling or other client-side modifications to the overlay. Image server 120 may transmit the native source image and overlay rendering to the client device for display (Step 750).

It will be apparent to those skilled in the art that various modifications and variations can be made to the disclosed systems and methods for measuring orthopedic parameters associated with a reconstructed joint in orthopedic arthroplastic procedures. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for dynamic image rendering in a client-server environment, comprising:
receiving, at a processor associated with an image server, information indicative of a display resolution associated with a client device;
determining, by the processor, that the display resolution of the client device is greater than a native resolution of a source image;
transmitting, by the processor to the client device, the source image at its native resolution;
rendering, by the processor at the image server, an overlay at the display resolution associated with the client device; and
transmitting, by the processor to the client device, the overlay.

2. The method of claim 1, wherein determining that the display resolution of the client device is greater than the native resolution includes determining that the client device is configured for scaling the source image from the native resolution of the source image to the display resolution associated with the client device.

3. The method of claim 1, wherein rendering the overlay includes generating at least one of text information associated with the source image, one or more orientation labels associated with the source image, or one or more measurement grids associated with the source image.

4. The method of claim 1, wherein transmitting the source image includes providing a notification with the source image, the notification configured to cause the client device to wait for the overlay before rendering the source image.

5. The method of claim 1, further comprising:
receiving a request for a second source image, the second source image related to the source image;
determining that the second source image requires the same overlay as the source image; and
providing the second source image to the client device, the second source image including information for causing the client device to render the overlay with the second source image.

6. A method for dynamic rendering of diagnostic image information in a client-server environment, comprising:
receiving, at a processor associated with an imaging server, a request for diagnostic image data, the request having been generated at a client device;
determining, by the processor, a graphics rendering capability associated with the client device;
customizing a graphics rendering process to be performed by the processor, based, at least in part, on the graphics rendering capability associated with the client device;
generating, by the processor using the selected graphics rendering process, an image associated with the received request for diagnostic image data; and
transmitting, by the processor to the client device, the generated image for display on the client device.

7. The method of claim 6, wherein determining the graphics rendering capability associated with the client device includes determining whether an image rendering service of the client device is configured to render an overlay layer relative to the generated image.

8. The method of claim 7, wherein determining whether the image rendering service of the client device is configured to render the overlay layer includes determining whether the image rendering service is configured to render at least one of text information relative to the image, one or more orientation reference parameters relative to the image, or one or more measurement grids relative to the image.

9. The method of claim 7, wherein customizing the graphics rendering processing includes:
determining, by the processor, that the graphics rendering capability associated with the client device includes a capability to render the overlay layer;
determining, by the processor, whether the image rendering service associated with the client device includes an image scaling capability; and
establishing server-side graphics rendering parameters based on the graphics rendering capability and the image scaling capability.

10. The method of claim 6, wherein determining the graphics rendering capability associated with the client device includes determining whether an image rendering service of the client device is configured to scale a digital image before display on the client device.

11. The method of claim 10, further comprising determining that the image rendering service of the client device is configured to scale the digital image, wherein generating the image further comprises rendering the image at a resolution associated with a native resolution of the image.

12. The method of claim 10, further comprising determining that the image rendering service of the client device is incapable of scaling the digital image, wherein generating the image further comprises rendering the image at a display resolution of the client device.

13. A dynamic image rendering system in a client-server environment, comprising:
an image rendering service running on a client device and configured to render images for display at the client device;
a server device communicatively coupled to the image rendering service running on the client device, the server device comprising a processor configured to:
receive information indicative of a display resolution associated with the client device;
determine that the display resolution of the client device is greater than a native resolution of a source image;
transmit the source image at its native resolution to the client device;
generate an overlay at the display resolution associated with the client device; and
transmit the overlay to the client device.

14. The dynamic image rendering system of claim 13, wherein determining that the display resolution of the client device is greater than the native resolution includes determining that the client device is configured for scaling the source image from the native resolution of the source image to the display resolution associated with the client device.

15. The dynamic image rendering system of claim 13, wherein rendering the overlay includes generating at least one of text information associated with the source image, one or more orientation labels associated with the source image, or one or more measurement grids associated with the source image.

16. The dynamic image rendering system of claim 13, wherein the processor is further configured to transmit the source image along with a notification, the notification configured to cause the client device to wait for the overlay before rendering the source image.

17. The dynamic image rendering system of claim 13, wherein the processor is further configured to:
receive a request from the client device for a second source image, the second source image related to the source image;
determine that the second source image requires the same overlay as the source image; and
provide the second source image to the client device, the second source image including information for causing the client device to render the overlay with the second source image.

18. The dynamic image rendering system of claim 13, wherein the image rendering service is configured to:
receive the source image from the server device;
receive the overlay from the server device;
scale the source image to a resolution associated with a display of the client device;
cause display of the scaled source image and the overlay on the display.

19. The dynamic image rendering system of claim 13, wherein the processor is further configured to:
receive a request from the client device for a second source image, the second source image related to the source image;
determine that the second source image requires the same overlay as the source image; and
provide the second source image to the client device, the second source image including information for causing the client device to render the overlay with the second source image.
